(19) United States
(12) Patent Application Publication
(10) Pub. No.: US 2018/0110328 A1
(43) Pub. Date: Apr. 26, 2018

(54) Multi-Function Playground Equipment

(71) Applicant: BCI Burke Company, LLC, Fond du Lac, WI (US)

(72) Inventors: Bart Mayer, Fond du Lac, WI (US); David Hillenbrand, Fond du Lac, WI (US); Scott Liebelt, Oakfield, WI (US)

(21) Appl. No.: 15/793,159

(22) Filed: Oct. 25, 2017

Related U.S. Application Data
(60) Provisional application No. 62/412,453, filed on Oct. 25, 2016.

(51) Int. Cl. A47B 37/04; A63B 9/00; B62H 3/00

(52) U.S. Cl. CPC A47B 37/04; A63B 2009/006; B62H 3/00; A63B 9/00

(57) ABSTRACT

The present invention provides an assembly of playground equipment elements that provide dual functions of seating for parenting caregivers as well as play elements for children. Accordingly, the present invention provides are outdoor table apparatus and a park bench functioning as both adult seating and child play apparatus. The park bench may also function as a bicycle parking rack.

### CROSS-REFERENCE TO RELATED APPLICATIONS

This application claims the benefit of U.S. Provisional Application No. 62/412,453, filed Oct. 25, 2016, and hereby incorporated by reference.

### BACKGROUND OF THE INVENTION

The present invention relates to playground equipment with dual function capabilities, and in particular, to an outdoor table and a park bench that function at least as adult seating and child play equipment.

Playground areas are designed to allow children to play, commonly utilizing recreational equipment such as slides, swing sets, seesaw's, merry-go-round, jungle gyms, etc. Typically, these playground areas are positioned such that the children's play area is spatially separated from adult or caregiver sitting, observation, or waiting areas. For example, outdoor tables and park benches are usually arranged around the periphery of or adjacent to the playground areas, thus spatially separated from the playground areas. In this respect, adults supervise the children from a distance without interfering with the child's play.

It has been desired to increase the amount of interaction between children and adults in play. Not only does play have the benefits of social, emotional, cognitive and physical growth in children but play involving interaction between children and adults has the added benefits of parent-child bonding that benefits both the child and adult. In addition, less accidents may occur when the parent or caregiver is present within the child play area.

### SUMMARY OF THE INVENTION

The present inventors have recognized that playground equipment that is built for the dual purpose of play and adult seating integrates the adult supervision areas within the child playground area facilitating parent-child interaction. The integration of site amenities, for example, benches, tables, and chairs for adult seating and hike parking racks into the playground area places the adult immersed within the child play area.

Accordingly, the present invention provides in one embodiment an outdoor table apparatus also functioning as a child play climbing apparatus and support structure, and in another embodiment a park bench also functioning as a child play climbing apparatus and bike rack.

In one embodiment, the present invention may be a dual function outdoor picnic table assembly adapted to support a seated human user adjacent a work table having a tabletop having an upwardly exposed work surface extending along a horizontally plane and elevated above a ground; a pole extending upwardly and downwardly along a vertical plane from the ground to a height above the tabletop at an edge of the tabletop and supporting at least a first end of the tabletop above the ground; and at least one stool having an upwardly exposed seat surface extending along a second horizontal plane parallel the first horizontal plane and adjacent the tabletop to allow the seated human user to work on the work surface while also seated on the at least one stool.

It is thus a feature of at least one embodiment of the invention to incorporate site amenities into play areas and also allow the possibility of an outdoor classroom.

The pole may be at least three times the height of the tabletop. The pole may have an upper end supporting a canopy above the tabletop.

It is thus a feature of at least one embodiment of the invention to provide a climbing pole and canopy support structure that also functions to support an outdoor tabletop.

The tabletop may have a plurality of holes therein permitting debris to fall from the work surface to the ground. The at least one stool may have a plurality of holes therein permitting debris to fall from the seat surface to the ground.

It is thus a feature of at least one embodiment of the invention to keep the tabletop and stool surfaces easy to clean and maintain.

A second pole may extend upwardly and downwardly along a vertical plane from the ground to a height above the tabletop and support a second end of the tabletop opposite the first end to raise the tabletop above the ground. A table leg may extend downwardly from a downwardly exposed surface opposite the work surface of the tabletop and supporting on a second end of the tabletop opposite the first end to raise the tabletop above the ground.

It is thus a feature of at least one embodiment of the invention to provide a play area allowing the support poles to support an overhanging canopy assembly or other adjacent structures.

A shape of the tabletop may provide convex and concave curves corresponding with interfitting concave and convex curves, respectively, of the at least one stool.

It is thus a feature of at least one embodiment of the invention to place the tabletop and stools in close proximity to facilitate climbing therebetween.

The pole may have a diameter between 2.5 inches and 3 inches.

It is thus a feature of at least one embodiment of the invention to allow children to slide down the pole.

In one embodiment, the present invention may be a dual function outdoor park bench adapted to support a seated human user and secure a parked bicycle having a seat having an upwardly exposed seat surface extending along a horizontal plane and adapted to support the seated human user; an upstanding seatback adjacent the seat extending along a vertical plane with a support face adapted to support a back of the seated human user; and a pair of lateral side frames each having a circular outer frame secured to a ground and capturing downwardly extending arms of the seated human user and having laterally extending intersecting bars extending across the interior of the outer frame to support opposite lateral sides of the seat and opposite lateral sides of the upstanding seatback and to provide at least two interconnecting bars with closed ends attached to the outer frame or the other interconnecting bars for receiving a bicycle lock secured thereto.

It is thus a feature of at least one embodiment of the invention to incorporate site amenities (e.g., bike parking rack) into the play environment to promote socialization and multi-generational interaction.

The intersecting bars may be bent at angles. The intersecting bars may be three intersecting bars forming three polygonal faces within the interior of the outer frame. The intersecting bars may extend across a left lateral side to a right lateral side of the outer frame.

It is thus a feature of at least one embodiment of the invention to permit climbing, hanging, or sitting by children on the lateral side frames using small spacing between bars.

The outer frame is shaped as a major segment of a bisected circle.

It is thus a feature of at least one embodiment of the invention to provide a comfortable armrest.

The seat may have a plurality of holes therein permitting debris to fall from the work surface to the ground. The seatback may have a plurality of holes therein permitting debris to fall from the support surface to the ground.

It is thus a feature of at least one embodiment of the invention to permit ease of cleaning and maintenance of the outdoor park bench.

These particular objects and advantages may apply to only some embodiments falling within the claims and thus do not define the scope of the invention.

### BRIEF DESCRIPTION OF THE DRAWINGS

FIG. 1 is an upper perspective view of an outdoor table, of a first embodiment of the present invention, showing climbing seats surrounding a tear drop shaped counter supported by a sliding support pole at at least one end;

FIG. 2 is a side perspective view of the outdoor table of the present invention;

FIG. 3 is a side perspective view of a park bench, of a second embodiment of the present invention, showing a seat and seatback supported by side end bike racks and climbing structure;

FIG. 4 is a side elevation view of the park bench of FIG. 3 showing the crossbars of the side end bike rack and climbing structure; and

FIG. 5 is a perspective view of an alternative embodiment of the park bench, showing the bench without a seat back and used in connection with a free-standing bike rack.

### DETAILED DESCRIPTION OF THE INVENTION

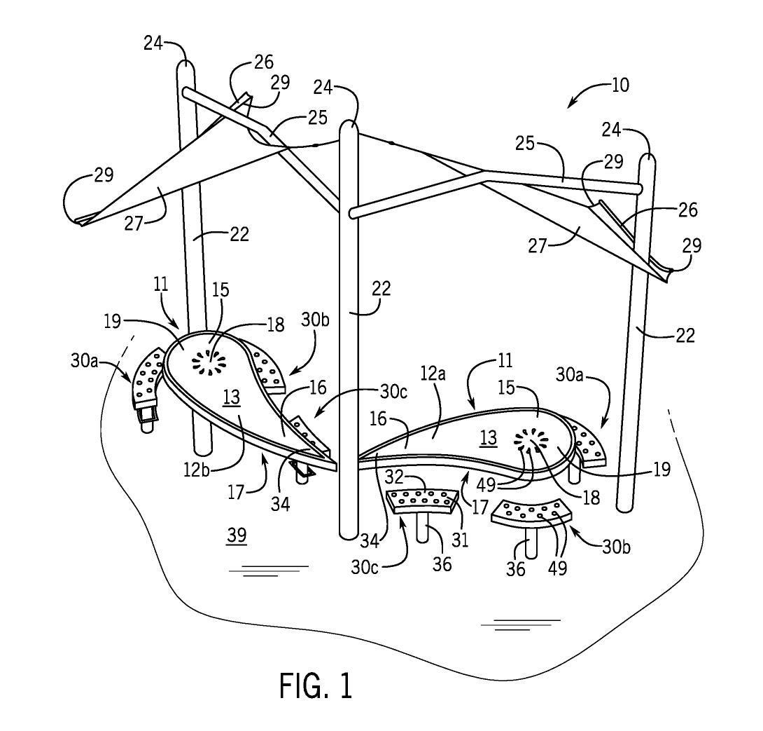

Referring to FIG. 1, an outdoor table assembly 10 positioned within a playground area provides a pair of tables 11 having countertops 12 (12a, 12b) presenting an upper work surface 13 extending generally along a horizontal plane 14 and on which objects may be placed, for example, to allow for eating, writing, working, or playing games. The countertops 12 may provide a substantially planar and level upper work surface 13.

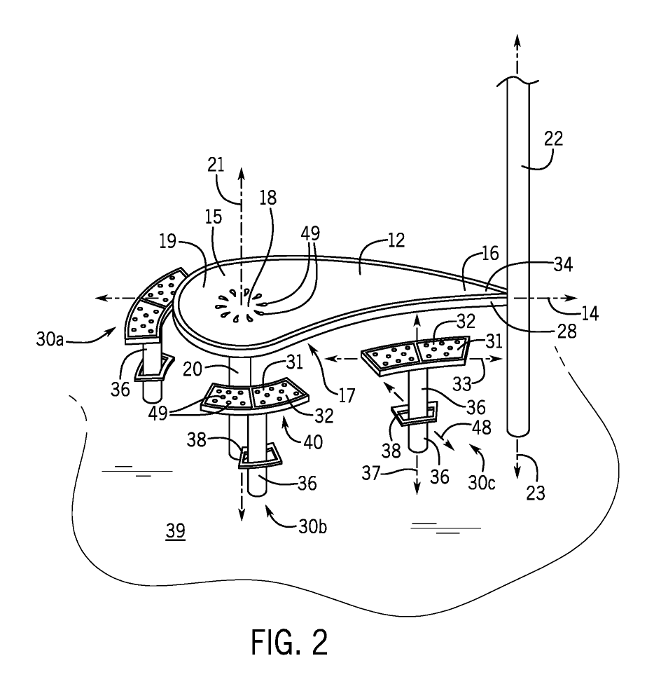

Referring now to FIGS. 1 and 2, the countertops 12 may be shaped so as to provide a teardrop or droplet shaped upper work surface 13 having a circular round end 15 tapering to an opposite triangular pointed end 16. The circular round end 15 may taper to the opposite triangular pointed end 16 along a curve to resemble a slight swirl toward a direction left or right. For example, the circular round end 15 is shown tapering to the left in FIG. 1 and shown tapering to the right in FIG. 2. While the countertops 12 are depicted as teardrop or droplet shaped, it is understood that the countertops 12 may take any desired shape, for example, round, circular, oblong, oval, rectangular, square, triangular, etc. The countertops 12 may be made of a rigid material such as a metal, steel, plastic, wood, or aluminum.

The countertops 12 may include a plurality of holes 49 provided therein and extending between the upper work surface 13 and a lower surface 17 positioned generally parallel and opposite the upper work surface 13. The holes 49 may be oval or oblong shaped holes having a large diameter of about half an inch to two inches and a small diameter of about half an inch to two inches whereby the large diameter is greater than the small diameter to define an oval. The holes 49 may be sized to allow dirt, dust, debris and moisture to fall from the upper work surface 13 of the countertops 12 to a generally horizontally extending ground surface 39 therebelow. For example, the area of the holes 49 may be at least ¼ square inch and as much as 4 square inches. While the holes 49 are depicted as oval shaped, it is contemplated that the holes 49 may be any desired shape, for example, round, circular, rectangular, square, triangular, teardrop/droplet, etc.

The plurality of holes 49 may be arranged in particular design configurations that may assist with catching debris but not interfering with providing a smooth work surface. For example, the holes 49 may be oval shaped holes 49 arranged in a circular configuration toward a center 18 of the circular round end 15 to depict a starburst or sun ray design. It is contemplated that the holes 49 may be positioned proximate the center 18 of the circular round end 15 so that a smooth work surface of the upper work surface 13 is still provided along an outer perimeter 19 of the upper work surface 13. While the holes 49 are depicted in a circular configuration, it is contemplated that the design configuration of the holes 49 may be any arrangement including a random scattered design and designs forming other geometric shapes and formations.

The circular round end 15 of the countertop 12a may be supported vertically above the ground surface 39 by a cylindrical leg 20 providing a tube, pipe or column extending downward generally along a vertical axis 21 from the lower surface 17 of the countertop 12a to the ground surface 39. The cylindrical leg 20 may be attached to the lower surface 17 of the countertop 12a near a center 18 of the circular round end 15. While the leg 20 is depicted as extending from the center 18 of the circular round end 15, it is understood that the cylindrical leg 20 may be attached at any location of the lower surface 17. The cylindrical leg 20 may be made of a rigid material such as a metal, steel, plastic, wood, or aluminum. The cylindrical leg 20 may position the countertop 12a at a height of at least 25 inches and as much as 30 inches above the ground surface 39.

A tip 34 of the opposite triangular pointed end 16 of the countertop 12a may be supported vertically above the ground surface 39 by a longitudinally extending pole 22 attached to a side edge 28 of the triangular pointed end 16 and extending upwardly and downwardly therefrom generally along a vertical axes 23 between the ground surface 39 and an upper end 24 of the pole 22. While the pole 22 is depicted as being attached to the tip 34, it is understood that the pole 22 may be attached at any side edge 28 position of the triangular pointed end 16 or may even extend through the countertop 12a. The pole 22 may attach to the countertop 12a to position the countertop 12a at a height of at least 25 inches and as much as 30 inches above the ground surface 39.

The pole 22 may be a metal tube or pipe similar to a fireman's pole. The pole 22 may be about 2.5 inches to 3 inches in diameter. A height of the pole 22 may be about 80 inches to 300 inches tall, 120 inches to 140 inches tall, or at least four or five times the height of the countertop 12a. The poles 22 may function as a climbing or sliding pole for children.

Referring to FIG. 1, the upper end 24 of the poles 22 may support laterally extending rods 25 extending therebetween adjacent poles 22 (or freestanding adjacent poles 22) of the countertops 12 to interconnect upper ends 24 of adjacent poles 22. The laterally extending rods 25 may be substantially straight or bent.

The upper end 24 of the poles 22 may also support curved mounting rods 26, for example, U-shaped rods used for suspending canopies 27 or other tented material or structure therebetween opposite ends 29 of the curved mounting rods 26. The canopies 27 may be attached to the curved mounting rods 26 and/or poles 22 or laterally extending rods 25 by ropes and clips. The canopies 27 may provide sun or rain protection over the countertops 12.

It is understood that the poles 22 may be used as a support structure for overhanging structures such as laterally extending rods 25, curved mounting rods 26, and canopies 27 as shown and/or support other ground components such as an adjacent countertop 12 or other playground structures.

While it is shown that the countertop 12a may be supported by the cylindrical leg 20 on one end 15 and the pole 22 on the opposite end 16, it is understood that countertops 12 may be supported by any combination of support legs 20 or poles 22 such as supported at opposite ends by two cylindrical legs 20 or supported at opposite ends by two poles 22 (as also depicted by countertop 12b in FIG. 1), and either end of the countertops 12 may be supported by either the cylindrical legs 20 or poles 22. It is also contemplated that the support legs 20 and poles 22 may be positioned at any location of the countertop 12 and that any number of legs 20 and/or poles 22 may be attached.

Referring again to FIGS. 1 and 2, positioned adjacent to and surrounding the countertops 12 are step stools 30 (30a, 30b, 30c) presenting a seat pan 31 presenting an upper surface 32 extending generally along a horizontal plane 33 and on which a human user may sit. The seat pan 31 may provide a substantially planar upper surface 32 or be slightly curved to conform to the human user's body. The seat pan 31 may have an arc shaped upper surface 32, when viewed from above, and resembling a closed segment of a curve.

The seat pans 31 may include a plurality of holes 49 provided therein and extending between the upper surface 32 and a lower surface 40 positioned generally parallel and opposite the upper surface 32 and are similar to the holes 49 described above with respect to the countertops 12. The holes 49 provided in the seat pans 31 may be round shaped holes 49 having a diameter of about half an inch to 2 inches. Again, the holes 49 allow dirt, dust, debris and moisture to drop from the upper surface 32 to the ground surface 39 there below. The holes 49 may also be in a desired shape as described above. The plurality of holes 49 may be arranged in the seat pans 31 in a scattered arrangement but may also be arranged in any desired geometric configuration.

A single pedestal 36 may extend downwardly from the lower surface 40 of the seat pan 31 generally along a vertical axis 37 to the ground surface 39 to provide a vertical height to the seat pan 31. The pedestal 36 may position the seat pan 31 at a height of at least 15 inches and as much as 20 inches. It is understood that the height of the seat pans 31 may vary for different step stools 30 while still allowing a child to climb on top of the seat pan 31 of at least some of the step stools 30 around the countertops 12.

The pedestal 36 may support a foot rest 38 extending substantially horizontally along axis 48 and perpendicular to the vertical axis 37 at a position between the ground surface 39 and the seat pan 31 or at approximately one third the height of the pedestal 36 where the human user may rest their feet. The foot rest 38 may be an arc shaped outer frame providing an inner are attached to the pedestal 36 and an outer are extending outwardly from the pedestal 36.

In one embodiment of the present invention, a first 30a and second 30b step stool are positioned around the elliptical round end 16 of the countertop 12 and a third step stool 30c may be positioned along the convex curve of the pointed end 16. Although three step stools 30 are shown, it is understood that any number of step stools 30 may be arranged around the countertop 12 and at any position around the countertop 12.

The step stools 30 may be positioned around the countertops 12 whereby the curves of the arc shaped seat pan 31 correspond with the curves of the teardrop shaped countertops 12. For example, a concave curve of the countertops 12 may be met by an adjacent interfitting convex curve of the seat pan 31 and a convex curve of the countertops 12 may be met by an adjacent interfitting concave curve of the seat pan 31. Although the seat pan 31 are shown as arc shaped, it is understood that the seat pan 31 may take any desired shape, for example, round, circular, rectangular, square, triangular, teardrop/droplet, etc.

The step stools 30 may be positioned in lateral proximity to the countertop 12 such that the countertops 12 slightly overlap the seat pans 31 or the seat pans 31 are less than 6 inches away from countertops 12. It is understood that the proximity between the seat pans 31 and the countertops 12 allow a child to easily climb from the seat pans 31 to the countertops 12.

It is also understood that the height difference between the seat pans 31 and the countertops 12 also allow a child to climb from the seat pan 31 to the countertops 12. For example, a height difference between the seat pans 31 and the countertops 12 may be less than 12 inches.

In use, the step stools 30 may be used by the human adult by sitting on the seat pan 31 at the countertop 12 and using the work surface provided by the upper work surface 13. The step stool 30 may also be used by the child for climbing on top of the step stool 30 and on top of the countertop 12. The child may use the poles 22 for climbing or sliding. The poles 22 may also be used as support structures for the countertops 12 and as a support for overhanging structures such as canopies 27 or adjacent ground structures.

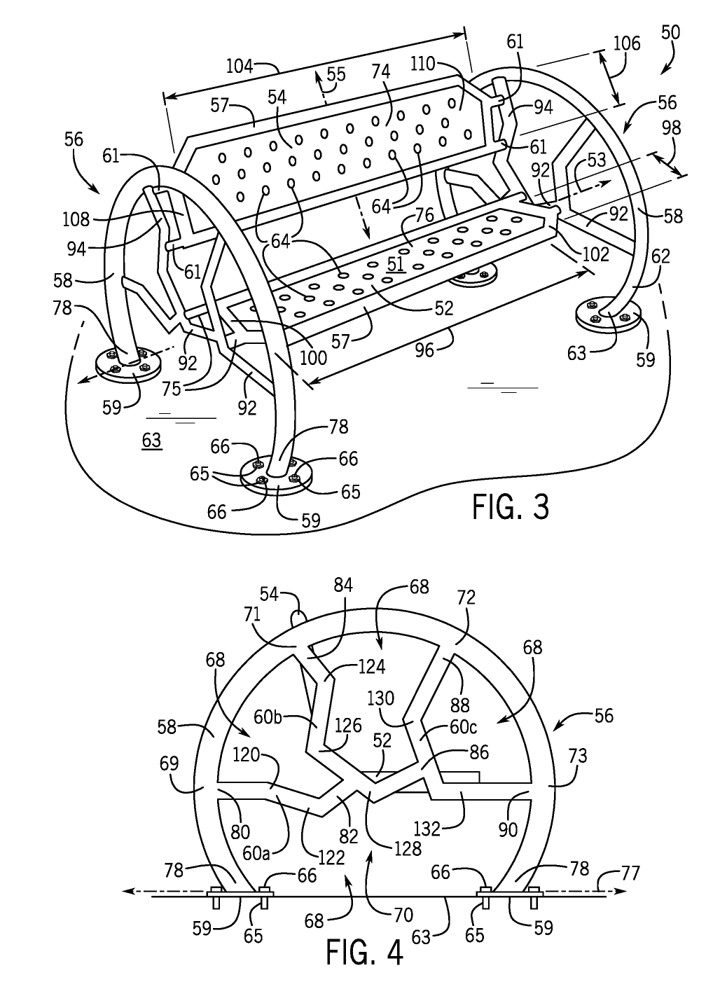

Referring now to FIGS. 3 and 4, in a second embodiment of the present invention, an outdoor park bench 50 positioned within a playground area may provide a seat pan 52 presenting an upper surface 51 extending generally along a horizontal axis 53 on which a human user may sit. The seat pan 52 may provide a rectangular bench providing a substantially planar and level surface. The seat pan 52 may have a length 96 extending along the horizontal axis 53 greater than a depth 98 extending perpendicular to the horizontal axis 53, for example, the length 96 is at least four times greater than the depth 98 allowing multiple human users to sit along the length 96 of the seat pan 52 on the upper surface 51 and the depth 98 permitting thighs of the human user to be properly supported thereunder by the seat pan 52.

The seat pan 52 may be supported by a seat frame 57 defining a perimeter of the seat pan 52 and providing a pair of horizontally extending support bars 75 at opposite left lateral 100 and right lateral 102 ends of the seat frame 57 permitting attachment of the seat flame 57 to lateral side frames 56 as further described below. The seat frame 57 may be metal, steel or iron support bars or tubes bent to conform to the outer perimeter of the seat pan 52

A seatback 54 may extend upward at a rear 76 of the seat pan 52 generally along a vertical axis 55 to support the back of the human user thereagainst. The seatback 54 may be slightly angled with respect to a vertical position such as a slight rearward recline between zero and 15° from vertical. The seatback 54 may provide a rectangular plank providing a substantially planar support face 74 against which the human user rests their back in a seated position. The seatback 54 may have a length 104 extending perpendicular to the vertical axis 55 greater than a height 106 extending along the vertical axis 55, for example, the length 104 is at least four times greater than the height 106 providing back support for multiple human users sitting along the length 104 of the seat pan 52 and the height 106 providing a broad surface supporting a thoracic back portion of the human user. The length 104 of the seatback 54 may generally correspond with the length 96 of the seat pan 52.

The seatback 54 may be supported by a seatback frame 57 defining a perimeter of the seatback 54 and providing a pair of horizontally extending support bars 61 at opposite left lateral 108 and right lateral 110 ends of the seatback 54 permitting attachment of the seatback 54 to the lateral side frames 56 as further described below. The seatback frame 57 may be metal, steel or iron support bars or tubes bent to conform to the outer perimeter of the seatback 54.

The seat pan 52 and seatback 54 may be supported in relative relationship with respect to each other and above the ground surface 63 by lateral side frames 56 supporting the seat pan 52 and seatback 54 at their left lateral 100, 108 and right lateral 102, 110 ends respectively. The lateral side frames 56 comprise circular outer frames 58 that are generally shaped as a major segment of a bisected circle whereby opposite ends 78 of a chord bisecting the circle are mounted to the ground surface 63 by ground plates 59 extending generally along a horizontal plane 77 extending substantially parallel to and along the ground surface 63. The ground plates 59 provide circular plates with evenly, radially spaced vertically extending holes 65 receiving vertically extending lock bolts 66 therein for mounting to the ground surface 63. The lateral side frames 56 may be metal, steel or iron support bars or tubes, and the ground plates 59 may be metal plates.

The circular outer frame 58 supports therein internal crossbars 60 (60a, 60b, 60c) extending between opposite ends of the circular outer frame 58 to provide three irregular shaped polygonal faces 68 within the circular outer frame 58 formed by the crossbars 60 and outer frame 58, and a fourth face 68 formed with the ground surface 63. The crossbars 60 may be irregular, jagged rods producing irregular shaped polygonal faces 68 resembling fractured or cracked solid materials such as cement or clay soil.

As best seen in FIG. 4 when viewed from a left elevation view of the bench 50, in one embodiment of the present invention, the internal crossbars 60 may include a first crossbar 60a with a first end 80 attached to and extending rightwardly from a left side 69 of the circular outer frame 58 toward a center 70 of the circular outer frame 58 to a first bend 120, then extending downwardly and rightwardly to a second bend 122, then extending upwardly and rightwardly toward the center 70 to meet a second crossbar 60b at an opposite second end 82. The second crossbar 60b may have a first end 84 attached to and extending downwardly and rightwardly from an upper left side 71 of the circular outer frame 58 toward the center 70 of the circular outer frame 58 to a first bend 124, then extending downwardly and leftwardly to a second bend 126, then extending downwardly and rightwardly toward the center 70 to meet the first crossbar 60a and further extending to a third bend 128 before extending upwardly and rightwardly to meet a third crossbar 60c at an opposite second end 86. The third crossbar 60c may have a first end 88 attached to and extending downwardly and leftwardly from an upper right side 72 of the circular outer frame 58 toward a center 70 of the circular outer frame 58 to a first bend 130, then extending downwardly and rightwardly to meet the second crossbar 60b and further extending to a third bend 132 before extending rightwardly to an opposite second end 90 attached to a right side 73 of the circular outer frame 58. The bends may be curved or angled. The left lateral and right lateral circular outer frames 58 may be mirror images of each other.

The distal ends of the support bars 75 of the seat frame 57 may attach to lateral side frames 56 at lower ends 92 of the second crossbar 60b and third crossbar 60c. The distal ends of the support bars 61 of the seatback 54 may attach to lateral side frames 56 at upper end 94 of the second crossbar 60b.

The crossbars 60 may be spaced such that a child may climb from crossbar 60 to crossbar 60 with ease. The crossbars 60 also allow the child to climb on the irregular, jagged bends of each crossbar 60. In this respect, the crossbars 60 may be at most spaced 6 inches apart. The crossbars 60 may be bent metal, steel or iron bars or tubes.

The seat pan 52 and seatback 54 may have a plurality of holes 64 allowing dirt, dust, and moisture to fall from the upper surface 51 and support face 74 of the seat pan 52 and seatback 54, respectively, through the holes 64 and to the ground surface 63 below. The holes 64 may be similar to the holes 49 described above with respect to the outdoor table assembly 10. The holes 64 may be oval or oblong shaped holes having a large diameter of about half an inch to two inches and a small diameter of about half an inch to two inches whereby the large diameter is greater than the small diameter to define an oval. While shown as ovals, the holes 64 may take any desired shape, for example, round, circular, rectangular, square, triangular, teardrop/droplet, etc. and may be positioned anywhere within the seat pan 52 and seatback 54, For example, the plurality of holes 64 may be arranged in a scattered arrangement but may also be arranged in any desired geometric configuration.

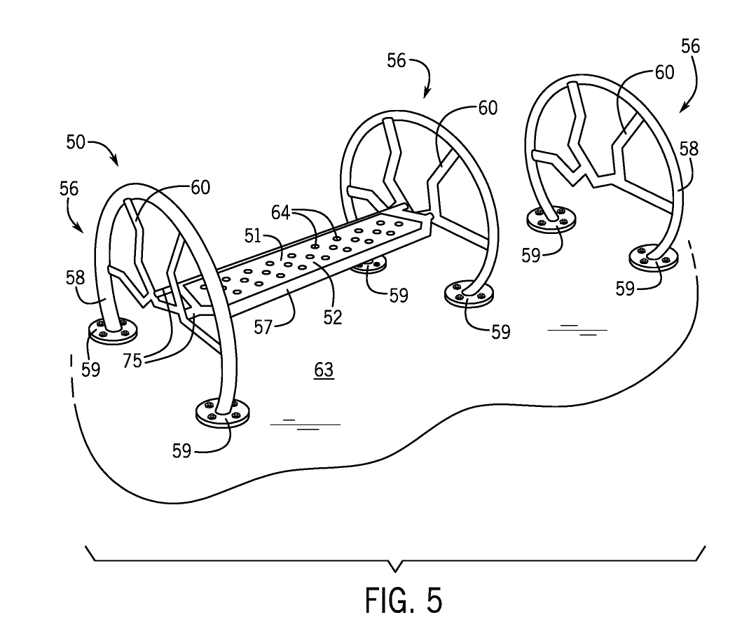

Referring now to FIG. 5 showing in alternative embodiment of the present invention, an outdoor park bench 50 positioned within the playground area may provide a seat pan 52 similar to the park bench 50 described with respect to FIGS. 3 and 4, except that the park bench 50 does not include a seatback 54. It is understood that the park bench 150 may include similar elements to the park bench 50 described above with respect to FIGS. 3 and 4.

It is also shown that the park bench 50 may be used in conjunction with a freestanding bike rack 134 standing separate from the park bench 50 but having a similar construction as one of the lateral side frames 56 of the park bench 50. In this respect the lateral side frames 56 of the park bench 50 may include the circular outer frame 58, internal crossbars 60 and ground plate 59 securing the circular outer frame 58 to the ground to be used as a standalone bike rack within the same playground area.

In use, the outdoor park bench 50 may be used by the adult for sitting within the playground area whereby the adult sits in the seat pan 52 with their back is supported by the seatback 54 and their arms are supported by the circular outer frame 58 as armrests. The outdoor park bench 50 may also be used by children for climbing on the seat pan 52 and the internal crossbars 60 of the outer frame 58. The outer frame 58 may also be used to secure a bike for parking purposes. A bike may be placed adjacent to and parallel to the circular outer frame 58 and permitting the bike to be attached at multiple crossbars 60 by receiving a bike lock therearound the crossbars 60.

Certain terminology is used herein for purposes of reference only, and thus is not intended to be limiting. For example, terms such as “upper”, “lower”, “above”, and “below” refer to directions in the drawings to which reference is made. Terms such as “front”, “back”, “rear”, “bottom” and “side”, describe the orientation of portions of the component within a consistent but arbitrary frame of reference which is made clear by reference to the text and the associated drawings describing the component under discussion. Such terminology may include the words specifically mentioned above, derivatives thereof, and words of similar import. Similarly, the terms “first”, “second” and other such numerical terms referring to structures do not imply a sequence or order unless clearly indicated by the context.

When introducing elements or features of the present disclosure and the exemplary embodiments, the articles “a”, “an”, “the” and “said” are intended to mean that there are one or more of such elements or features. The terms “comprising”, “including” and “having” are intended to be inclusive and mean that there may be additional elements or features other than those specifically noted, it is further to be understood that the method steps, processes, and operations described herein are not to be construed as necessarily requiring their performance in the particular order discussed or illustrated, unless specifically identified as an order of performance. It is also to be understood that additional or alternative steps may be employed.

It is specifically intended that the present invention not be limited to the embodiments and illustrations contained herein and the claims should be understood to include modified forms of those embodiments including portions of the embodiments and combinations of elements of different embodiments as come within the scope of the following claims. All of the publications described herein, including patents and non-patent publications, are hereby incorporated herein by reference in their entireties.

What we claim is:

1. A dual function outdoor picnic table assembly adapted to support a seated human user adjacent a work table comprising:
a tabletop having an upwardly exposed work surface extending along a horizontally plane and elevated above a ground;
a pole extending upwardly and downwardly along a vertical plane from the ground to a height above the tabletop at an edge of the tabletop and supporting at least a first end of the tabletop above the ground; and
at least one stool having an upwardly exposed seat surface extending along a second horizontal plane parallel the first horizontal plane and adjacent the tabletop to allow the seated human user to work on the work surface while also seated on the at least one stool.

2. The outdoor table of claim 1 wherein the pole is at least three times the height of the tabletop.

3. The outdoor table of claim 2 wherein the pole has an upper end supporting a canopy above the tabletop.

4. The outdoor table of claim 1 wherein the tabletop has a plurality of holes therein permitting debris to fall from the work surface to the ground.

5. The outdoor table of claim 1 wherein the at least one stool has a plurality of holes therein permitting debris to fall from the seat surface to the ground.

6. The outdoor table of claim 1 further comprising a second pole extending upwardly and downwardly along a vertical plane from the ground to a height above the tabletop and supporting a second end of the tabletop opposite the first end to raise the tabletop above the ground.

7. The outdoor table of claim 1 further comprising a table leg extending downwardly from a lowerly exposed surface opposite the work surface of the tabletop and supporting on a second end of the tabletop opposite the first end to raise the tabletop above the ground.

8. The outdoor table of claim 1 wherein a shape of the tabletop provides convex and concave curves corresponding with interfitting concave and convex curves, respectively, of the at least one stool.

9. The outdoor table of claim 1 wherein the pole has a diameter between 2.5 inches and 3 inches.

10. A dual function outdoor park bench adapted to support a seated human user and secure a parked bicycle comprising:
a seat having an upwardly exposed seat surface extending along a horizontal plane and adapted to support the seated human user; and
a pair of lateral side frames each having a circular outer frame secured to a ground and capturing downwardly extending arms of the seated human user and having laterally extending intersecting bars extending across the interior of the outer frame to support opposite lateral sides of the seat and opposite lateral sides of the upstanding seatback and to provide at least two interconnecting bars with closed ends attached to the outer frame or the other interconnecting bars for receiving a bicycle lock secured thereto.

11. The outdoor park bench of claim 10 wherein the intersecting bars are bent at angles.

12. The outdoor park bench of claim 10 wherein the intersecting bars are three intersecting bars forming three polygonal faces with the outer frame within the interior of the outer frame.

13. The outdoor park bench of claim 10 wherein the intersecting bars extend across a left lateral side to a right lateral side of the outer frame.

14. The outdoor park bench of claim 10 wherein the outer frame is shaped as a major segment of a bisected circle.

15. The outdoor park bench of claim 10 wherein the seat has a plurality of holes therein permitting debris to fall from the work surface to the ground.

16. The outdoor park bench of claim 10 wherein the seatback has a plurality of holes therein permitting debris to fall from the support surface to the ground.
